(19) United States
(12) Patent Application Publication
(10) Pub. No.: US 2005/0093776 A1
(43) Pub. Date: May 5, 2005

(54) Plasma display device and method for driving same

(75) Inventors: Takashi Furutani, Tokyo (JP); Toshihiro Yoshioka, Tokyo (JP)

Correspondence Address: YOUNG & THOMPSON, 745 SOUTH 23RD STREET, 2ND FLOOR, ARLINGTON, VA, 22202, US

(73) Assignee: NEC PLASMA DISPLAY CORPORATION, TOKYO (JP)

(21) Appl. No.: 10/951,765

(22) Filed: Sep. 29, 2004

(30) Foreign Application Priority Data
Oct. 30, 2003 (JP) 2003-370095

(51) Int. Cl. G09G 3/28; G09G 3/36

(52) U.S. Cl. 345/60

(57) ABSTRACT

A plasma display device and its driving method are provided which are capable of displaying an excellent image, without an increase in costs caused by an increased number of driving circuits, by shortening a scanning period while writing discharge is made to occur with reliability and by improving contrast. In a plasma display panel (PDP) in the plasma display device, a group of unit cells is formed at intersecting points between each of groups of row electrodes and a group of column electrodes. Each of unit cells is made up of a display cell and auxiliary cell and is surrounded by a horizontal rib and a longitudinal rib. A horizontal communicating aperture is formed in the longitudinal rib to partition among two or more auxiliary cells and a longitudinal communicating aperture is formed in the horizontal rib to partition between the display cell and auxiliary cell both being arranged in the column direction.

### BACKGROUND 0F THE INVENTION

1. Field of the Invention

The present invention relates to a plasma display device and a method for driving the plasma display device and more particularly to a three-electrode surface-discharge AC (Alternating Current)—type plasma display device including a plasma display panel (hereinafter simply called a “PDP”) as a main component.

The present application claims priority of Japanese Patent Application No. 2003-370095 filed on Oct. 30, 2003, which is hereby incorporated by reference.

2. Description of the Related Art

In recent years, a plasma display device having a PDP as its main component, in general, since it has many advantages in that, when compared with conventionally-used display devices such as a CRT (Cathode Ray Tube) device, an LCD (Liquid Crystal Display) device, or a like, less flicker occurs, a display contrast ratio is larger, displaying on a larger screen is made possible, it can be made thinner, it can give a quicker response, or a like, is being widely and increasingly used as a display device for an information processing device such as a computer, flat TV (Television), or a like.

The PDP is roughly classified, depending on its operating method, into two types, one being an AC-type PDP whose electrode (row electrode made up of a scanning electrode and a sustaining electrode described later) is coated with a transparent dielectric layer and which is operated indirectly in an alternating-current discharge state and another being a DC (Direct Current)—type PDP whose electrode is exposed in discharge space and which is operated in a direct-current discharge state. The AC-type PDP, in particular, has a comparatively simple structure and can realize displaying on a large area with ease and, therefore, it is being widely used. Such the PDP is basically constructed so as to be made up of a front substrate (first substrate) and a rear substrate (second substrate) in a manner in which the two substrates face each other and a discharge gas space placed between the two substrates in which plasma is generated is formed.

Among the AC-type PDPs described above, a three-electrode surface-discharge type AC-type PDP is the most widely used. In the three-electrode surface-discharge AC-type PDP, groups of row electrodes each group being made up of one of scanning electrodes and one of sustaining electrodes (called common electrodes since the common electrodes are electrically and commonly connected to one another), both the scanning electrodes and sustaining electrodes being placed in parallel to one other along a horizontal direction (row direction) are formed on an inner face of a front substrate being one substrate making up a pair of the above substrates between which a unit cell (discharge cell) of the PDP is formed and a group of column electrodes made up of data electrodes (also called address electrodes) being placed in a manner orthogonal to the row electrodes, described above, along a vertical direction (column direction) are formed on an inner face of a rear substrate being another substrate making up the pair of the above substrates. A reason why the three-electrode surface-discharge AC-type PDP is the most widely used is that, since an ion of high energy being generated while surface discharge occurs on the inner face of the front substrate does not collide with a phosphor layer formed on the inner face of the rear substrate, a life of a PDP can be made longer. Also, a color plasma display device having such the three-electrode surface-discharge AC-type structure as above is available. In the three-electrode surface-discharge AC-type color plasma display device which enables emission of light in multicolor, phosphor layers including one that emits red (R) color light, second one that emits green (G) color light, and third one that emits blue (B) color light are formed on its inner surface.

FIG. 15 is a perspective view schematically illustrating configurations of a PDP 100 making up a main component of the conventional three-electrode surface-discharge AC-type plasma display device (hereinafter the three-electrode surface-discharge AC-type PDP device being simply called a “plasma display device”). As shown in FIG. 15, the PDP 100 has a basic structure in which a front substrate 101 (first substrate) and a rear substrate 102 (second substrate) are placed in a manner in which the front substrate 101 and rear substrate 102 face each other and between the front substrate 101 and the rear substrate 102 is formed a discharge gas space 103. The front substrate 101 includes a first insulating substrate 104 made of a transparent material such as glass or a like, groups of row electrodes placed on an inner face of the first insulating substrate 104 in parallel to one another along a row direction (horizontal direction) H, each of the groups having a scanning electrode 105 made up of a transparent electrode 105A on a part of which a bus electrode 105B (also called a trace electrode) made of a metal material is formed which is used to reduce electrical resistance in the transparent electrode 105A and a sustaining electrode 106 made up of a transparent electrode 106A on a part of which a bus electrode 106B (also called a trace electrode) made of a metal material which is also used to reduce electrical resistance in the transparent electrode 106A, both the scanning electrode 105 and the sustaining electrode 106 facing each other with a surface discharge gap 107 interposed between the scanning electrode 105 and the sustaining electrode 106, a transparent dielectric layer 108 with which the groups of row electrodes each being made up of the scanning electrode 105 and sustaining electrode 106 are coated, and a protecting layer 109 used to protect the transparent dielectric layer 108 from discharge.

The rear substrate 102 includes a second insulating substrate 112 made of a transparent material such as glass or a like, data electrodes (address electrodes) 113 making up a group of column electrodes formed on an inner face of the second insulating substrate 112 in a direction (vertical direction) V being orthogonal to the row direction H, a white dielectric layer 114 with which the data electrode 113 is coated, for example, stripe-shaped ribs 115 which provide the discharge gas space 103 to be filled with discharge gas and which is formed along the column direction v to partition an individual unit cell, and phosphor layers 116 which are formed in a position to coat bottom surfaces and wall surfaces of the ribs 115 and which converts an ultraviolet ray produced by gas discharge into visible light.

FIG. 16 is a plan view schematically for illustrating arrangements of electrodes employed in the PDP 100 of FIG. 15. As shown in FIG. 16, the PDP 100 includes groups of row electrodes (display electrodes) made up of m-pieces scanning electrodes 105 (S1, S2, S3, . . . Sm) and the sustaining electrodes 106 (common electrodes) (C) and a group of column electrodes made up of n-pieces of data electrodes (address electrodes) 113 (D1, D2, D3, . . . ,Dn) on an inner face of the rear substrate 102 in a column direction being orthogonal to the groups of row electrodes. One unit cell 130 (hereinafter simply called a “cell”) is formed at an intersecting point among one scanning electrode making up the groups of the row electrodes, one sustaining electrode making up the common electrodes, and one data electrode making up the group of column electrodes and a group of cells is arranged in a matrix form in the row direction H and the column direction V. In the case of displaying in monochrome, one pixel is made up of one cell. In the case of color displaying, one pixel is made up of three cells (one cell emitting R color light, second cell emitting G color light, and third cell emitting B color light).

FIG. 17 is a plan view schematically illustrating part of arrangements of electrodes employed in the PDP 100 of FIG. 16. An example is shown in FIG. 17 in which three cells including a cell “(n−1)”, cell “n”, and cell “(n+1)” which are formed in a manner to be adjacent to one another are used. For example, the cell “n” placed in a central position is made up of three electrodes including one scanning electrode 105 (Sn) and one sustaining electrode 106 (C) both being arranged in parallel to each other, and one data electrode 113 arranged in a direction orthogonal to a direction in which the scanning electrode 105 and sustaining electrode 106 are arranged.

Next, a method for driving the PDP 100 described above is explained using waveforms of applied voltages by referring to FIG. 18. When a PDP is driven, one screen is displayed during one field TF (1/60 seconds) which is made up of two or more sub-fields TSs in combination. Each of the sub-fields is used to display gray levels as described later. One sub-field includes a pre-discharging period T1, a scanning period T2, and a sustaining period T3. To drive the PDP 100, by applying a scanning pulse P8, during the scanning period T2, to each of the scanning electrodes 105 in the front substrate 101 and, at the same time, by applying a data pulse P9 to the data electrode 113 in the rear substrate 102, writing discharge to select a cell to be discharged (that is, to be lit) is made to occur. Then, during the sustaining period T3, control is exercised so that sustaining discharge is made to occur by surface discharge between the scanning electrode 105 and sustaining electrode 106 in the selected cell. Whether or not such the surface discharge is made to occur in the cell is determined by controlling amounts of charges that are produced or erased on the transparent dielectric layer 108 formed on the scanning electrode 105 and sustaining electrode 106 on the front substrate 101 in a manner to cover these electrodes 105 and 106. At this time point, the discharged cell (lit cell) is distinguished from a non-distinguished cell (non-lit cell) by using two types of data pulses each having a different voltage to be applied when writing discharge is made to occur during the scanning period T2. For example, in FIG. 8, a cell to which a data pulse P9 with a voltage of several tens of volts is applied is turned ON to be lit, while a cell to which no data pulse is applied is not turned ON.

During the sustaining period T3, by alternately applying a group of sustaining pulses 10 between the scanning electrode 105 and sustaining electrode 106 in all the cells, sustaining discharge is made to occur for displaying only in the cells which were turned ON during the scanning period T2. After termination of the sustaining discharge, in order to make preparations, during the pre-discharging period T1, so that writing discharge is made to occur in a subsequent sub-field, by applying a sustaining erasing pulse P5 to all cells that have been lit, pre-discharge is made to occur to erase wall charges formed by the sustaining discharge. Also, during the pre-discharging period T1, in order to cause subsequent writing discharge to occur easily, following the pre-discharge, priming pulses P6 and P7 are applied to all cells to cause priming discharge to occur. In the above descriptions, for easy understanding, the writing discharge in the scanning period T2 and the sustaining discharge in the sustaining period T3 are explained prior to descriptions of pre-discharge and priming discharge occurring during the pre-discharging period T1, however, during one sub-field TS, each discharge is made to occur in the order shown in FIG. 18.

Next, displaying of gray levels is described by referring to FIG. 19. In the PDP 100, to achieve sufficient displaying of gray levels that can correspond fully to a level of brightness, as shown in FIG. 19, one field TF being a period of time during which one screen is displayed is so configured as to be made up of two or more sub-fields TSs, for example, eight sub-fields from TS1 to TS5. As described above, each of the sub-fields TS1 to TS5 includes the pre-discharge period T1, scanning period T2, and sustaining period T3. Here, each of the sub-fields TS1 to TS8 is so set that the sustaining period T3 in each of the sub-fields TS1 to TS8 has a different time length and, in the example of FIG. 19, weights of 1:2:4:8:16:32:64:128 are assigned respectively to the eight sub-fields TS1 to TS8. Therefore, in the example, displaying of 256 (2⁸) gray levels including 0 level of gray to 256 levels of gray is performed. For example, to select 100 levels of gray, light emission only in the sub-fields for 4 gray levels, 32 gray levels, and 64 gray levels is required. In the above example, eight sub-fields TS (TS1 to TS8) are set to perform displaying of 256 gray levels, however, in some cases, nine or more sub-fields TS are combined to provide redundancy.

When an image is displayed on a PDP making up a main component of a plasma display device, since light-emitting luminance is determined depending on time in a sustaining period T3 in each sub-field TS, that is, on time during which sustaining discharge occurs (or on the number of times of discharge), it is necessary to keep the time as long as possible. However, in reality, since the PDP tends to be made further big-screen which, as a result, increases the number of cells (pixels), if the PDP is made high-definition in a state where configurations of the PDP and methods for driving the PDP remain conventional, it is unavoidable that a ratio of a scanning period T2 to a period in each sub-field TS becomes large. Therefore, the sustaining period T3 is shortened.

As one example, in which 256 gray levels are displayed during 8 sub-fields (TS1 to TS8) as shown in FIG. 19, if a display screen is of an XVGA (Extended Video Graphics Array) class (number of scanning lines being 768) and when a period of time during which a scanning pulse P8 required for one-time writing discharge is applied is 2 microseconds (μs), a period of time of a scanning period T2 occupying in one second (time for one field) can be calculated by a following equation:
T2=2(μs)×768(scanning lines)×8(sub-fields)×60 ≈0.7373 seconds

Therefore, in this case, the scanning time T2 occupies two-thirds or more of one field. Here, if a display screen is of a VGA (Video Graphics Array) class being a lower class (scanning lines being 480) and when the same calculation as above is made, T2≈0.7373 seconds and, therefore, it is understood that, as the PDP is made high-definition, a ratio of a scanning period T2 to one field increases greatly. As a result, since time to be assigned to a sustaining period T3 becomes short, as described above, sufficient light-emitting luminance cannot be obtained, Therefore, it is expected that, by shortening a scanning period during which writing discharge is made to occur, a PDP can be made high-definition without a decrease in light-emitting luminance or that light-emitting luminance can be improved with a high-definition state being maintained.

Moreover, another problem having not yet been solved by the conventional configuration of a PDP and by the conventional driving method is contrast. That is, as shown in FIG. 18, in the conventional driving method, the pre-discharging period T1 is provided in every sub-field TS to cause pre-discharge to occur, however, since any sub-field TS is not selected due to light-emission caused by the pre-discharge (no writing discharge occurs), a phenomenon occurs in which some light emission occurs even in a cell in which black display should be made originally. As a result, since contrast in a PDP is lowered, a new plasma display device that can provide enhanced contrast is expected.

Conventionally, methods to solve these two problems associated with the conventional plasma display device are proposed. That is, several methods (means) to shorten a scanning period and to improve contrast while writing discharge is made to occur, with reliability, are proposed. First, the method to shorten a scanning period is explained.

(1) Method of Shortening Scanning Period

By shortening time of a scanning pulse P8 required for one-time writing discharge while maintaining conventional configurations of a PDP and its conventional driving method as they are, as shown in FIG. 18, the scanning period T2 is made shorter as a whole and the sustaining period T3 is made the longer. However, according to this method, since cells appear in which insufficient writing discharge occurs when time during which the scanning pulse P8 is applied is made shorter, a cell that should be lit originally is not lit, which, as a result, does not lead to improvement of light-emitting luminance. Therefore, it is impossible to shorten a scanning period without degradation in an image quality.

Also, a dual scanning method is proposed in which, by dividing a screen of a PDP into two, an upper screen and a lower screen to allot each data electrode to each of the upper and lower screens in each of which separate scanning is performed, a scanning period T2 is reduced to a half. However, this method has a problem in that, though the scanning period T2 can be reduced to a half, the number of circuits to drive each of data electrodes increases, which, as a result, causes high costs.

Also, a PDP and its driving method trying to solve the above problems are disclosed in Japanese Patent Application Laid-open No. 2002-297091 in which, by changing configurations of both the PDP and its driving method, time during which a scanning pulse PB is applied is made shorter to reduce a scanning period T2 as a whole. In the modified PDP and its driving method, a first auxiliary discharge electrode and a second auxiliary discharge electrode are formed, in advance, in parallel to each other, together with a scanning electrode and a sustaining electrode, on an inner face of a front glass substrate and, every time when a scanning pulse is applied to a scanning electrode, auxiliary discharge is made to occur between both the two auxiliary electrodes. Then, by letting space charges be generated by the auxiliary discharge and, when a scanning pulse is applied to a scanning electrode and a data pulse is applied to a data electrode, by using the space charges, writing discharge is made to occur for a shortened period of time.

Also, another PDP trying to solve the problem is disclosed in Japanese Patent Application Laid-open No. 2002-150949 in which such the auxiliary discharge not to be used for displaying is made to occur between a scanning electrode and a sustaining electrode. The disclosed PDP has a rib which is formed between a front substrate and a rear substrate and which extends in a column direction and a rib which partitions discharge space for every discharge cell in a row direction and a column direction, by using a rib extending in a row direction, wherein a rib placed among discharge cells arranged along rows being adjacent to each other is separated by a clearance being parallel to a row direction and a discharge portion in which priming discharge is made to occur in space in a clearance is formed in a portion in which row electrodes placed back to back with a pair of row electrodes being adjacent to each other face each other and wherein an inner portion within the clearance and an inner portion in the discharge cell being adjacent to a column direction communicate with each other via a groove formed by a bulk-increased dielectric layer. By configuring as above, priming particles produced by the auxiliary discharge spread and pass through the clearance in upper and lower cells being adjacent in a column direction and, therefore, a priming effect on sustaining discharge during a sustaining discharge period is exerted. Moreover, a priming effect on selective discharge in an address period is also exerted.

Next, a method of improving contrast being the second problem is described.

(2) Method of Improving Contrast

First, the simplest method is to reduce the number of times of pre-discharge. More specifically, unlike in the case shown in FIG. 18 where pre-discharge is made to occur in every sub-field TS, contrast can be improved by letting pre-discharge occur only once every several sub-fields. However, in this case, since the priming effect given by the pre-discharge decreases, if a width of a scanning pulse to be applied is the same as in the conventional case, writing discharge is not made to occur easily and a good image cannot be obtained.

Moreover, another PDP and its driving method to solve the above problem is disclosed in Japanese Patent No. 2655500 in which every two scanning electrodes and every two sustaining electrodes are alternately arranged and each priming cell is formed by one of scanning electrodes being adjacent to each other and by one of sustaining electrodes being adjacent to each other.

However, the PDP and its driving method disclosed in Japanese Patent Application Laid-open Nos. 2002-297091 and 2002-150949 and in Japanese Patent No. 2655500 have such problems as described below. That is, the PDP and its driving method disclosed in Japanese Patent Application Laid-open No. 2002-297091 has a problem in that application of a pulse having complicated waveform to the first and second newly-mounted auxiliary discharge electrodes is required and an increase in costs occurs which is caused by an increase in the number of driving circuits.

Next, the PDP and its driving method disclosed in the Japanese Patent Application Laid-open No. 2002-150949 has also a problem in that, though the increase in costs for driving circuits being the problem having occurred in the Japanese Patent Application Laid-open No. 2002-297091 can be avoided, if discharge cells being adjacent to each other in up and down directions are made simply to communicate with each other, sustaining discharge spreads easily in cells being adjacent to each other in a column direction via a gap among pairs of electrodes prepared to cause auxiliary discharge to occur and there is a fear of occurrence of erroneous discharge. To solve this problem, in the PDP and its driving method disclosed in Japanese Patent Application Laid-open No. 2002-150949, the groove is formed above a longitudinal rib on the bulk-increased layer; however, since the groove is mounted in a remote place, the priming effect has to ripple through such the far-located groove and, due to rippling in the far distance, the priming effect cannot be exerted sufficiently.

Moreover, the PDP disclosed in the Japanese Patent Application Laid-open No. 2002-1500949 has also such a problem as described below. In the disclosed PDP, there are two cases. In one of the two cases, every one scanning electrode and every one sustaining electrode are alternately arranged. In another case, every two scanning electrodes and every two sustaining electrodes are alternately arranged. In the former case, resetting discharge being made to occur before operations start in a scanning period occurs between the scanning electrode and sustaining electrode and, as a result, wall charges are formed. However, the resetting discharge does not occur in pairs of electrodes formed to cause auxiliary discharge to occur in the clearance being sandwiched between horizontal ribs and, therefore, no wall charges are formed. As a result, when a scanning pulse is applied, though an intense electric field by wall charges is generated in a display cell, no superimposed electric field by wall charges exists in a clearance and, therefore, no intense electric field is generated, That is, there is a problem that discharge to exert a priming effect does not occur easily in the clearance in a scanning period. On the other hand, in the latter case, the problem occurring in the former case is solved. However, since discharge occurs in a sustaining period, useless discharge occurs below a light-shielded portion every time a sustaining pulse is applied, causing an increase in power consumption. Moreover, the above method in which a scanning period is shortened is not effective in improving contrast being the second problem to be solved.

In the PDP and its driving method disclosed in Japanese Patent No. 2655500, since a priming cell and a display portion are integrally constructed, sustaining discharge spread in a manner to turn around the priming cell and, therefore, light is intercepted by the light-shielded portion in the priming portion and the intercepted light becomes useless. This means that light-emitting efficiency decreases, that is, an amount of power to be fed has to be increased to obtain the same light-emitting luminance. Also, since the priming discharge spreads in a manner to turn around the display portion, light emitted due to the priming discharge cannot be completely intercepted. This means that an effect to increase contrast is not complete. Moreover, the above method to improve contrast is not effective in shortening the scanning period being the first problem to be solved.

### SUMMARY OF THE INVENTION

In view of the above, it is an object of the present invention to provide a plasma display device and its driving method which are capable of displaying an excellent image, without an increase in costs caused by an increased number of driving circuits, by shortening a scanning period while writing discharge is made, with reliability, to occur and by improving contrast.

According to a first aspect of the present invention, there is provided a plasma display device including:
a plasma display panel (PDP) having a first substrate and a second substrate, both being arranged so as to face each other, discharge gas space formed between the first substrate and the second substrate, groups of row electrodes arranged on an inner face of the first substrate along a row direction, groups of column electrodes arranged on an inner face of the second substrate along a column direction so that the groups of row electrodes and the groups of column electrode intersect at right angles, and groups of unit cells formed at intersecting points between the groups of row electrodes and groups of-column electrodes,
wherein each of the unit cells is made up of each of display cells formed in a manner to be adjacent to one another along the column direction and used for displaying images and each of auxiliary cells to feed priming for writing discharge to each of the display cells and wherein each of the display cells and is surrounded by a longitudinal rib formed along the column direction and a horizontal rib formed along the row direction, and each of the auxiliary cells is surrounded by the longitudinal rib formed along the column direction and the horizontal rib formed along the row direction, and at least in the horizontal rib is formed each of longitudinal communicating apertures to make each of the display cells communicate with each of the auxiliary cells.

In the foregoing, a preferable mode is one wherein each of the horizontal communicating apertures to make the auxiliary cells being adjacent to one another communicate with one another is formed in the longitudinal rib.

Also, a preferable mode is one wherein the groups of row electrodes include at least one of scanning electrodes and groups of column electrodes are made up of data electrodes.

Also, a preferable mode is one wherein the groups of row electrodes include sustaining electrodes.

Also, a preferable mode is one wherein the groups of row electrodes include scanning electrodes and sustaining electrodes, and groups of column electrodes are made up of data electrodes, and
wherein, in each of the display cells, the scanning electrodes are arranged so as to face each other with a surface discharge gap being interposed between the scanning electrodes and, in each of the auxiliary cells, the sustaining electrodes are arranged so as to face each other with another surface discharge gap being interposed between the sustaining electrodes. Also, a preferable mode is one wherein, in each of the display cells, a transparent electrode of each of the scanning electrodes and a transparent electrode of each of the sustaining electrodes face each other with a surface discharge gap being interposed between these two transparent electrodes of each of the scanning electrodes and sustaining electrodes and, in each of the auxiliary cells, a bus electrode of each of the scanning electrodes and a bus electrode of each of the sustaining electrodes are arranged so as to face each other with a surface discharge gap between these two bus electrodes of each of the scanning electrodes and sustaining electrodes.

Also, a preferable mode is one wherein each of the scanning electrodes and each of the longitudinal communicating apertures do not overlap one another in a depth direction,

Also, a preferable mode is one wherein each of the auxiliary cells has a light-shielding portion to intercept light emitted by discharge.

Furthermore, a preferable mode is one wherein each of the auxiliary cells has no phosphor layer.

According to a second aspect of the present invention, there is provided a method for driving a plasma display device made up of a PDP having a first substrate and-a second substrate, both being arranged so as to face each other, discharge gas space formed between the first substrate and the second substrate, groups of row electrodes arranged on an inner face of the first substrate along a row direction, groups of column electrodes arranged on an inner face of the second substrate along a column direction so that the groups of row electrodes and the groups of column electrode intersect at right angles, and groups of unit cells formed at intersecting points between the groups of row electrodes and groups of column electrodes, wherein each of the unit cells is made up of each of display cells formed in a manner to be adjacent to one another along the column direction and used for displaying images and each of auxiliary cells to feed priming for writing discharge to each of the display cells and wherein each of the display cells is surrounded by a longitudinal rib formed along the column direction and a horizontal rib formed along the row direction, and each of the auxiliary cells is surrounded by the longitudinal rib formed along the column direction and a horizontal rib formed along the row direction, and at least in the horizontal rib is formed each of longitudinal communicating apertures to make each of the display cells communicate with each of the auxiliary cells, the method including:
a step of causing discharge to occur in each of the auxiliary cells, when a scanning pulse is applied to each of the scanning electrodes, irrespective of occurrence or non-occurrence of writing discharge in each of the display cells.

In the foregoing, a preferable mode is one wherein the step is achieved by making a negative charge be accumulated on each of the scanning electrodes in each of the auxiliary cells prior to application of the scanning pulse.

Also, a preferable mode is one wherein the step is achieved by applying a voltage having a waveform to cause discharge by using each of the scanning electrodes as an anode to occur only in each of the auxiliary cells before operations start in a scanning period.

Also, a preferable mode is one wherein the step is achieved by applying a voltage having a waveform to cause discharge by using each of the scanning electrodes as an anode to occur only in each of the auxiliary cells in a sustaining period.

Also, a preferable mode is one wherein the step is achieved by applying a voltage having a waveform to cause discharge by using each of the scanning electrodes as an anode to occur in each of the display cells and each of the auxiliary cells before operations start in a scanning period and by applying then a voltage having a waveform to cause discharge by using each of the scanning electrodes as a cathode to occur only in each of the display cells.

According to a third aspect of the present invention, there is provided a method for driving a plasma display device made up of a PDP having a first substrate and a second substrate, both being arranged so as to face each other, discharge gas space formed between the first substrate and the second substrate, groups of row electrodes arranged on an inner face of the first substrate along a row direction, groups of column electrodes arranged on an inner face of the second substrate along a column direction so that the groups of row electrodes and the groups of column electrode intersect at right angles, and groups of unit cells formed at intersecting points between the groups of row electrodes and groups of column electrodes, wherein each of the unit cells is made up of each of display cells formed in a manner to be adjacent to one another along the column direction and used for displaying images and each of auxiliary cells to feed priming for writing discharge to each of the display cells and wherein each of the display cells is surrounded by a longitudinal rib formed along the column direction and a horizontal rib formed along the row direction, and each of the auxiliary cells is surrounded by the longitudinal rib formed along the column direction and a horizontal rib formed along the row direction and at least in the horizontal rib is formed each of longitudinal communicating apertures to make each of the display cells communicate with each of the auxiliary cells, the method including:
a step of making a voltage of a sustaining pulse to be applied to each of the scanning electrodes on odd-numbered lines be in phase with a voltage of a sustaining pulse to be applied to each of the sustaining electrodes on even-numbered lines in a sustaining period, and by making a voltage of a sustaining pulse to be applied to each of the scanning electrodes on even-numbered lines be in phase with a voltage of a sustaining pulse to be applied to each of the sustaining electrodes on odd-numbered line in the sustaining period.

According to a fourth aspect of the present invention, there is provided a method for driving a plasma display device made up of a PDP having a first substrate and a second substrate, both being arranged so as to face each other, discharge gas space formed between the first substrate and the second substrate, groups of row electrodes arranged on an inner face of the first substrate along a row direction, groups of column electrodes arranged on an inner face of the second substrate along a column direction so that the groups of row electrodes and the groups of column electrode intersect at right angles, and groups of unit cells formed at intersecting points between the groups of row electrodes and groups of column electrodes, wherein each of the unit cells is made up of each of display cells formed in a manner to be adjacent to one another along the column direction and used for displaying images and each of auxiliary cells to feed priming for writing discharge to each of the display cells and wherein each of the display cells is surrounded by a longitudinal rib formed along the column direction and a horizontal rib formed along the row direction, and each of the auxiliary cells is surrounded by the longitudinal rib formed along the column direction and a horizontal rib formed along the row direction and at least in the horizontal rib is formed each of longitudinal communicating apertures to make each of the display cells communicate with each of the auxiliary cells, the method including:
a step of applying a sustaining pulse to cause discharge to occur in each of the auxiliary cells before first sustaining discharge starts to occur in each of the display cells in a sustaining period.

With the above configuration, when a scanning pulse is applied in a scanning period, auxiliary discharge occurs in each of auxiliary cells prior to occurrence of writing discharge and charged particles produced by the auxiliary discharge spread in each of display cells through each of longitudinal communicating apertures. At this time point, since the spread charged particles serve as a priming for writing discharge in each of the display cells, even a short scanning pulse can induce occurrence of writing discharge with reliability. Also, by forming a light-shielded portion in each of the auxiliary cells, degradation in contrast can be prevented. Moreover, since pre-discharge can be made to occur in each of the auxiliary cells, contrast can be improved more when compared with the case of the conventional driving method. Therefore, an excellent image can be displayed, without an increase in costs caused by the increased number of driving circuits, by simultaneous achievement of shortening of a scanning period while writing discharge is made to occur, with reliability, and of improvement of contrast.

### BRIEF DESCRIPTION OF THE DRAWINGS

The above and other objects, advantages, and features of the present invention will be more apparent from the following description taken in conjunction with the accompanying drawings in which:

FIG. 1 is a plan view schematically showing configurations of a PDP making up a main component of a plasma display device according to a first embodiment of the present invention;

FIG. 2 is a cross-sectional view of FIG. 1 taken along a line A-A;

FIG. 3 is a cross-sectional view of FIG. 1 taken along a line B-B;

FIG. 4 is a cross-sectional view showing an example of a partially modified configuration of the PDP shown in FIG. 1 taken along a line B-B;

FIG. 5 is a diagram showing waveforms of a voltage applied during a pre-discharging period when the PDP of FIG. 1 is driven;

FIG. 6 is a diagram showing waveforms of a voltage applied during a scanning period when the PDP of FIG. 1 is driven;

FIG. 7 is a diagram showing waveforms of a voltage applied during a sustaining period when the PDP of FIG. 1 is driven;

FIG. 8 is a plan view schematically illustrating operations of the PDP of FIG. 1 during the pre-discharging period when the PDP is driven;

FIG. 9 is a plan view schematically illustrating operations of the PDP of FIG. 1 during the scanning period when the PDP is driven:

FIG. 10 is a plan view schematically illustrating operations of the PDP of FIG. 1 during the sustaining period when the PDP is driven:

FIG. 11 is a diagram showing waveforms of another voltage applied during the pre-discharging period when the PDP of FIG. 1 is driven:

FIG. 12 is a diagram showing waveforms of still another voltage applied during the pre-discharging period when the PDP of FIG. 1 is driven;

FIG. 13 is a plan view schematically showing configurations of a PDP making up a main component of a plasma display device according to a second embodiment of the present invention;

FIG. 14 is a plan view schematically showing configurations of a PDP making up a main component of a plasma display device according to a third embodiment of the present invention;

FIG. 15 is a perspective view schematically illustrating configurations of a PDP making up a main component of a conventional plasma display device;

FIG. 16 is a plan view schematically illustrating arrangements of electrodes employed in the PDP of FIG. 15;

FIG. 17 is a plan view schematically illustrating part of arrangements of electrodes employed in the PDP of FIG. 16;

FIG. 18 is a diagram showing a method for driving the PDP of FIG. 17 by using waveforms of applied voltages; and

FIG. 19 is a diagram schematically illustrating a method for driving the PDP of FIG. 18.

### DETAILED DESCRIPTION OF THE PREFERRED EMBODIMENTS

Best modes of carrying out the present invention will be described in further detail using various embodiments with reference to the accompanying drawings.

A PDP making up a main component of a plasma display device of the present invention is so configured that a front substrate and a rear substrate are mounted so as to face each other, discharge gas space is formed between the front substrate and rear substrate, groups of row electrodes containing at least one of scanning electrodes are arranged on an inner face of the front substrate in a row direction and a group of column electrodes made up of data electrodes are arranged on an inner face of the rear substrate in a column direction being orthogonal to the groups of row electrodes, and a group of unit cells is arranged at intersecting points between the row electrode group and column electrode group, wherein each of the unit cells is made up of each of display cells used to display images and formed in the column direction in a manner to be adjacent to one another and of each of auxiliary cells used to feed a priming for writing discharge to the display cells and wherein the display cells and auxiliary cells are surrounded by a horizontal rib formed along the row direction and by a longitudinal rib formed along the column direction respectively and each of longitudinal communicating apertures used to make each of the display cells communicate with each of the auxiliary cells at least in the longitudinal rib. Also, according to the driving method of the plasma display device of the present invention, when a scanning pulse is fed to a cell during a scanning period, regardless of application of a data pulse, a high voltage exceeding a breakdown voltage (discharge starting voltage) is set so as to be applied between each of the scanning electrodes and each of the sustaining electrodes. Since, by doing such the setting, intense discharge occurs in a cell to be lit by application of a data pulse to cause writing discharge to occur, large amounts of wall charges are accumulated in a transparent dielectric layer. Therefore, in the lit cell, sustaining discharge is made to occur in a subsequent sustaining period. Contrary to the above, since a data pulse is not fed to a cell in which lighting is not desired (cell not to be lit), even if such the large voltage as exceeds the breakdown voltage is applied to the cell not to be lit, no intense discharge occurs therein and no writing discharge is made to occur and, therefore, no wall charges are accumulated in the transparent dielectric layer. As a result, sustaining discharge is not made to occur in the cell not to be lit in the subsequent sustaining period.

### First Embodiment

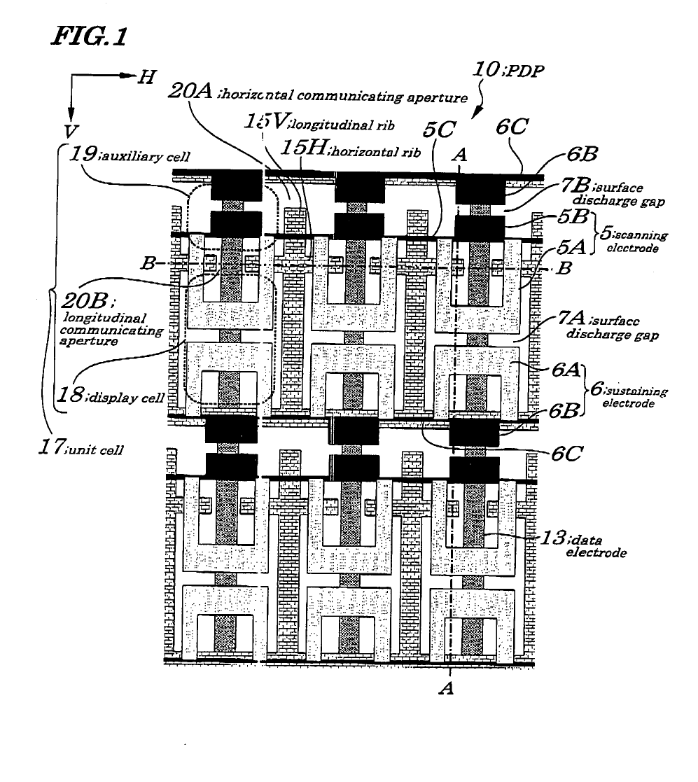

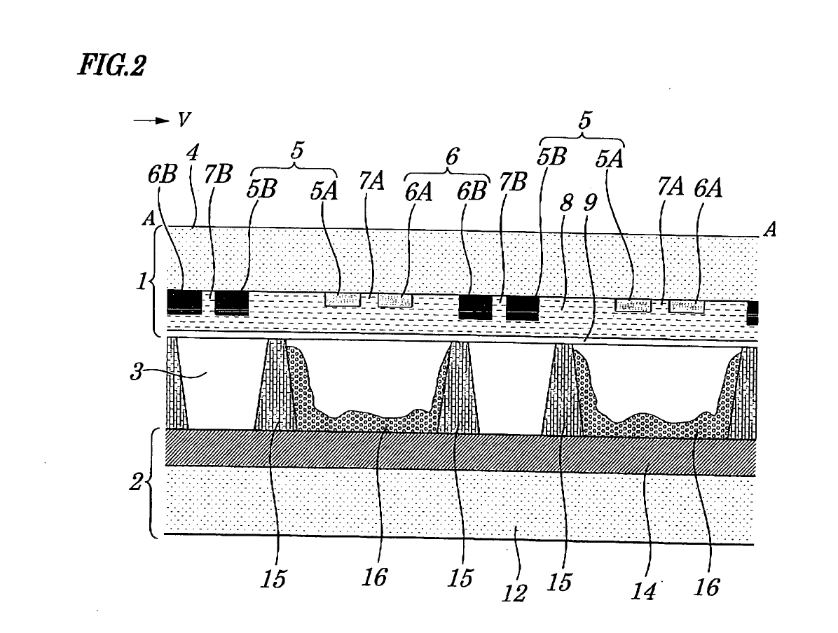

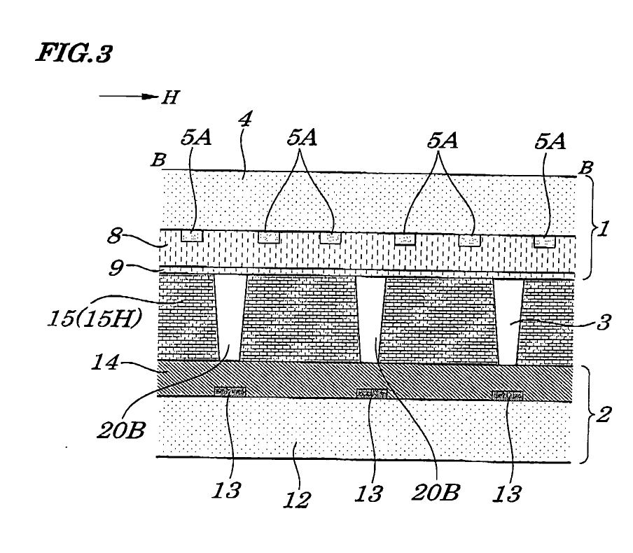

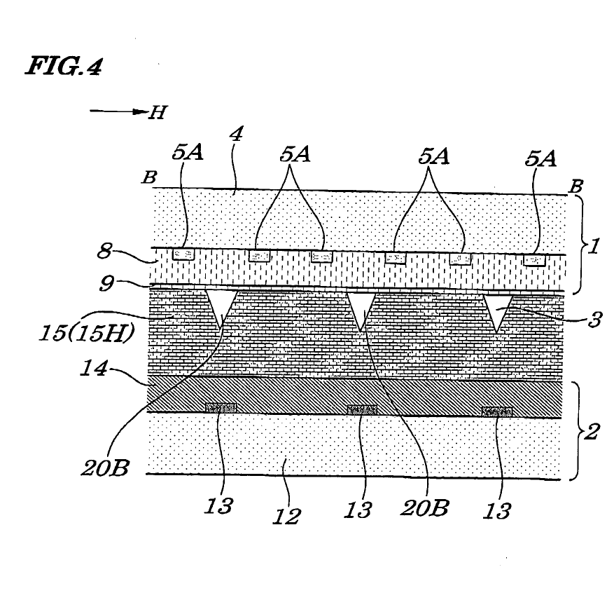

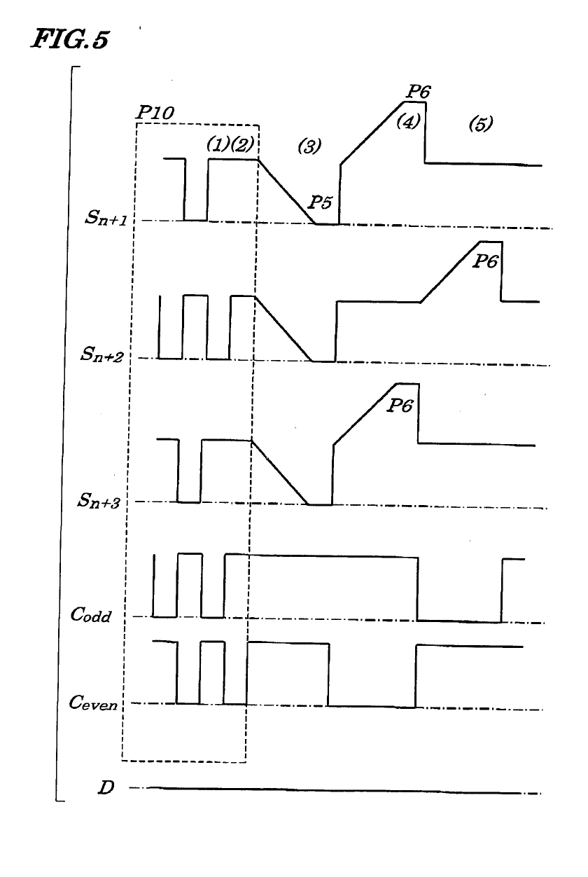

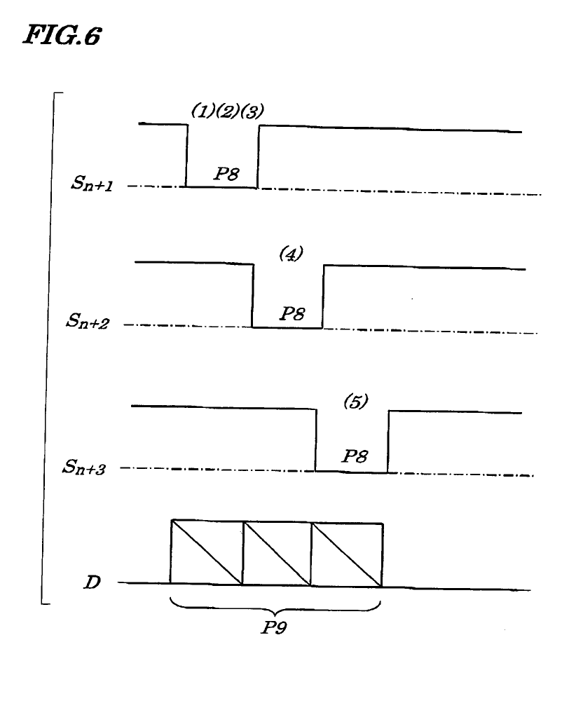

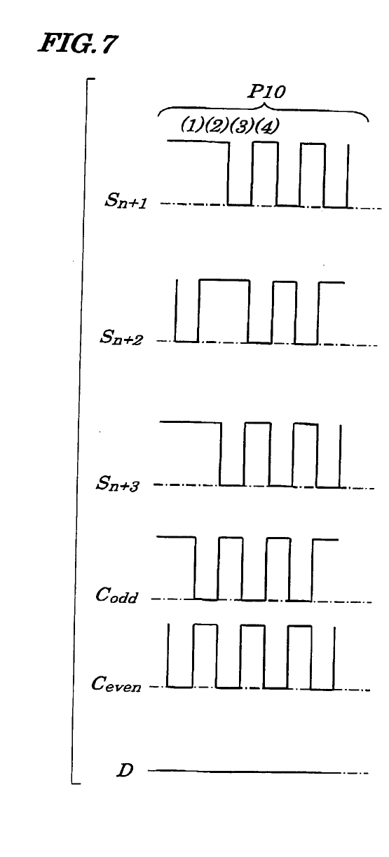

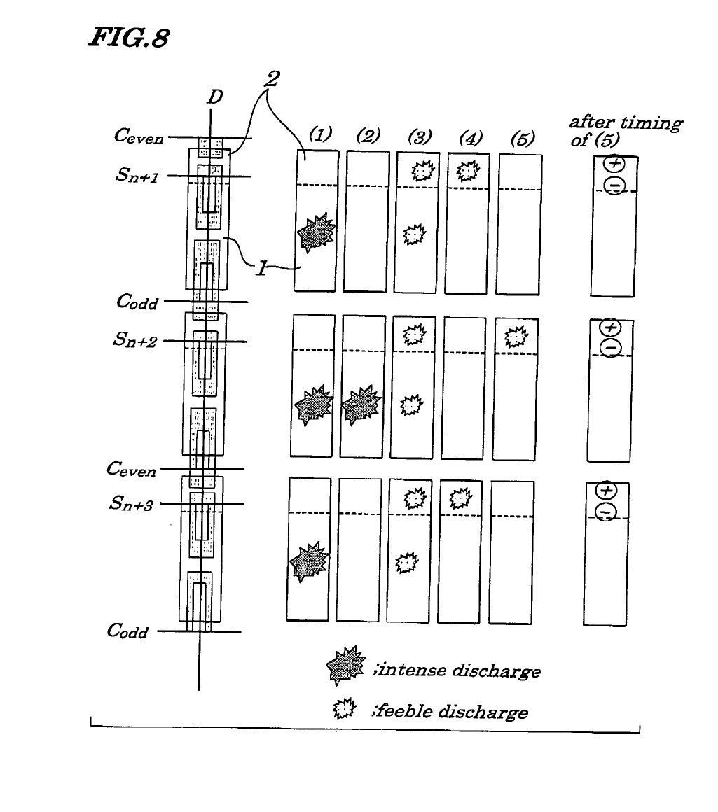

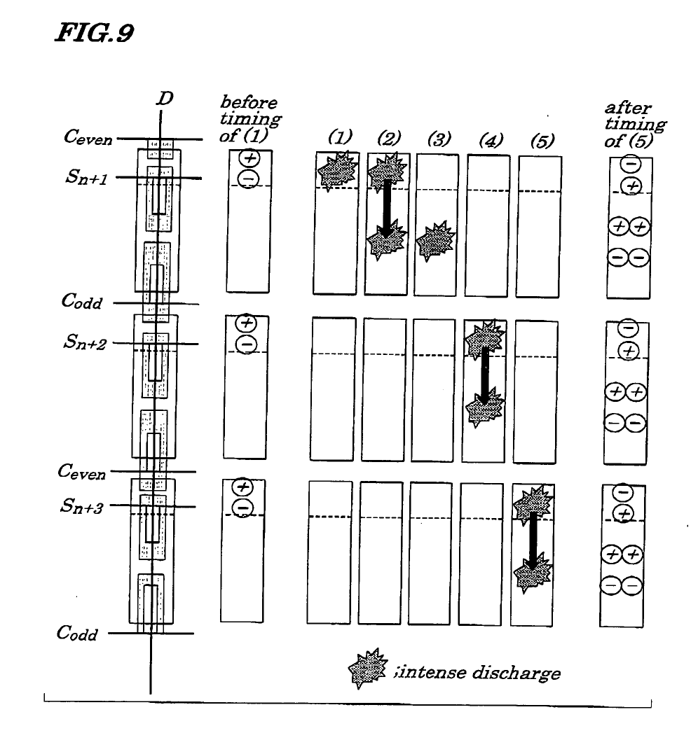

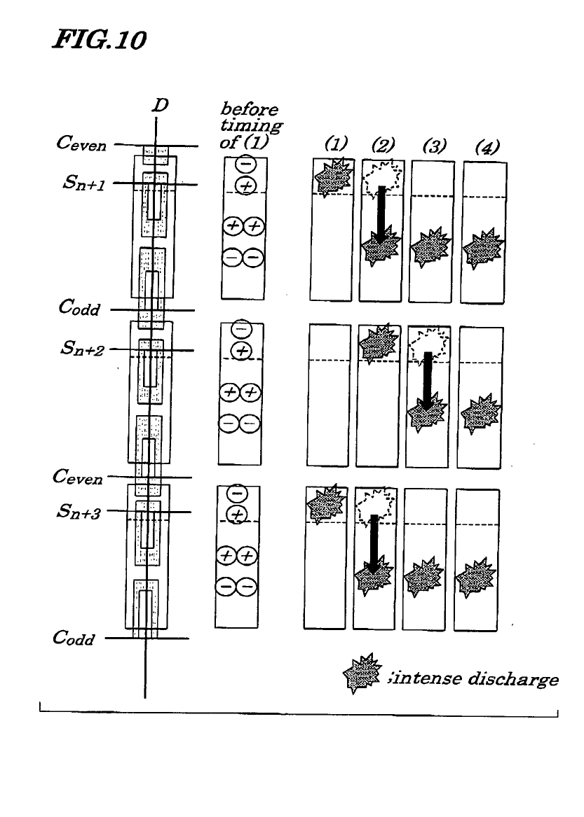

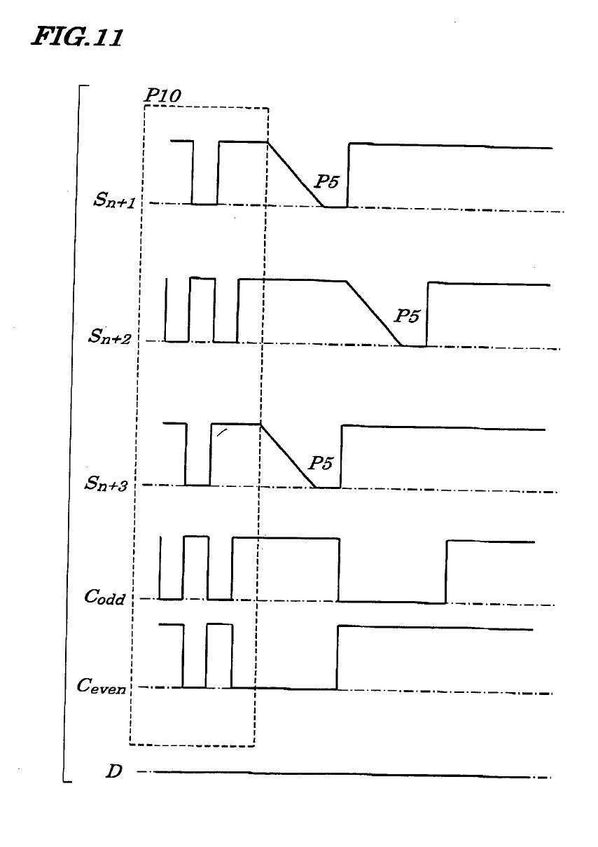

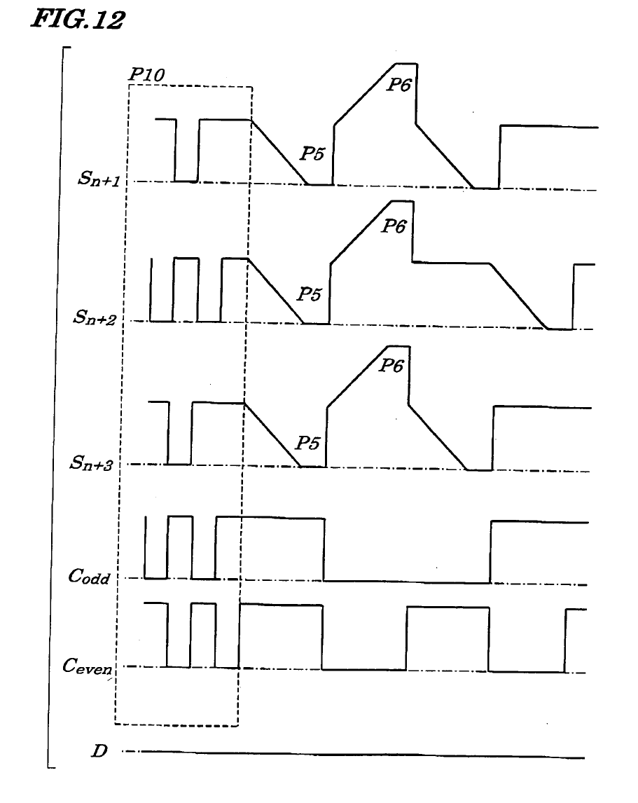

FIG. 1 is a plan view schematically showing configurations of a PDP 10 making up a main component of a plasma display device of a first embodiment of the present invention. FIG. 2 is a cross-sectional view of FIG. 1 taken along a line A-A. FIG. 3 is a cross-sectional view of FIG. 1 taken along a line B-B. FIG. 4 is a cross-sectional view showing an example of a partially modified configuration of the PDP shown in FIG. 1 taken along a line B-B. FIG. 5 is a diagram showing waveforms of a voltage applied during a pre-discharging period when the PDP 10 of FIG. 1 is driven. FIG. 6 is a diagram showing waveforms of a voltage applied during a scanning period when the PDP 10 of FIG. 1 is driven. FIG. 7 is a diagram showing waveforms of a voltage applied during a sustaining period when the PDP 10 of FIG. 1 is driven. FIG. 8 is a plan view schematically illustrating operations of the PDP 10 of FIG. 1 during the pre-discharging period when the PDP 10 is driven. FIG. 9 is a plan view schematically illustrating operations of the PDP 10 of FIG. 1 during the scanning period when the PDP 10 is driven. FIG. 10 is a plan view schematically illustrating operations of the PDP 10 of FIG. 1 during the sustaining period when the PDP 10 is driven. FIG. 11 is a diagram showing waveforms of another voltage applied during the pre-discharging period when the PDP 10 of FIG. 1 is driven. FIG. 12 is a diagram showing waveforms of still another voltage applied during the pre-discharging period when the PDP 10 of FIG. 1 is driven. The PDP 10 making up a main component of the plasma display device of the first embodiment, as shown in FIG. 1 to FIG. 3, has a basic configuration that a front substrate (first substrate) 1 and a rear substrate (second substrate) 2, both facing each other, are formed and that a discharge gas space 3 is formed between the front substrate 1 and the rear substrate 2.

The front substrate 1 has a first insulating substrate 4 being made of a transparent material such as sodalime glass or a like and having its thickness of 1 mm to 5 mm, each of scanning electrodes 5, which are arranged on an inner face of the first insulating substrate 4 in parallel to one another along a row direction H each facing one another and are made up of a transparent electrode 5A that makes up groups of a pair of row electrodes with a surface discharge gap 7A or a surface discharge gap 7B being interposed between the pairs of row electrodes and that are made of ITO (Indium Tin Oxide), SnO₂ (Tin Oxide), or a like and having its film thickness of 100 nm to 500 nm and are made up of a bus electrode (trace electrode) 5B formed on a part of the transparent electrode 5A to reduce electric resistance of the transparent electrode 5A and being made of a metal material such as Ag (silver), Al (aluminum), a multi-layer thin film made up of a Cr (chromium)/Cu (copper)/Cr film or a like, each of sustaining electrodes 6, which are arranged on the inner face of the first insulating substrate 4 in parallel to one another along a row direction H each facing one another and which are made up of each of transparent electrodes 6A that makes up groups of a pair of row electrodes each facing one another with the surface discharge gap 7A or 7B being interposed the pairs of row electrodes and that are made of ITO (Indium Tin Oxide), SnO₂ (Tin Oxide), or a like and having its film thickness of 100 nm to 500 nm and which are made up of a bus electrode (trace electrode) 6B formed on a part of the transparent electrode 6A to reduce electric resistance of the transparent electrode 6A and being made of a metal material such as Ag, Al, a multi-layer thin film made up of a Cr/Cu/Cr film or a like, a transparent dielectric layer 8 having its film thickness of 5 μm to 800 μm and being made of lead glass of a low melting point or a like which is used to coat the groups of the pair of row electrodes, and a protecting layer 9 having its film thickness of 0.5 μm to 2.0 μm and being made of MgO (magnesium oxide) or a like which is used to protect the transparent dielectric layer 8 from discharge.

The above transparent dielectric layer 8 is formed by coating the row electrode groups with a paste of the lead glass of a low melting point or a like and then baking entire portions thereof at a temperature exceeding a melting point of the paste. The protecting layer 9 is formed by depositing MgO or a like using a sputtering method, deposition method, or a like.

On the other hand, the rear substrate 2 has a second insulating substrate 12 being made of a transparent material such as sodalime glass or a like and having its thickness of 2 mm to 5 mm, each of data electrodes (address electrodes) 13 being made of Ag, Al, Cu, or a like and having its film thickness of 2 μm to 4 μm which is formed on an inner face of the second insulating substrate 12 in a column direction V orthogonal to the row direction H and which makes up a column electrode group, a white dielectric layer 14 being made of lead glass of a low melting point being mixed with a white pigment such as a titanium oxide powder, alumina powder or a like and having its film thickness of 5 μm to 40 μm, ribs 15 made up of a horizontal rib 15H and a longitudinal rib 15V which are made of frit glass containing lead and are used to provide the discharge gas space 3 being filled with discharge gas made up of a mixed gas of at least one of He (helium), Ne (neon), Ar (argon), Kr (krypton), Xe (xenon), N₂ (nitrogen), O₂ (oxygen), CO₂ (carbon dioxide), or a like and to partition unit cells 17, and a phosphor layer 16 formed at a bottom of the rib 15 and in a portion covering a wall side of the rib 15. The rib 15 is constructed so as to be of a parallel-cross shape formed by the horizontal rib 15H and longitudinal rib 15V.

The above white dielectric layer 14 is formed by coating the data electrode 13 with lead glass of a low melting point obtained by mixing a titanium oxide powder, alumina powder, or a like as a white pigment and then baking entire portions thereof. The rib 15 is formed by a screen printing method using a frit glass paste containing lead or alike, sandblast method, transfer method, or a like. The phosphor layer 16 is formed by applying a paste containing a phosphor material by the screen printing method or a like and then baking entire portions thereof. In the phosphor layer 16, to realize a color-display PDP (not shown in Figs), phosphors are painted on the phosphor layer 16 which includes one that emits red (R) color light, second one that emits green (G) color light, and third one that emits blue (B) color light, each making up three primary colors of light (not shown).

After having stuck the front substrate 1 and rear substrate 2 together with a sealing material such as lead glass frit or a like with a gap interposed between them and having fixed them, baking is performed at temperatures of 300° C. to 500° C. Then, air is exhausted from the discharge gas space 3, which is then filled with discharge gas such as He, Ne, Ar, or a like at a pressure of 200 to 700 Torr (Torricelli) for completion of fabrication of the PDP 10.

Next, configurations of the rib 15 (15H and 15V) and an arrangement of the electrodes employed in the PDP 10 of the first embodiment are described. Each of the unit cells 17 in the PDP 10, as shown in FIG. 1, is made up of each of the display cells 18 and each of an auxiliary cells 19, and each of the display cells 18 and each of the auxiliary cells 19 is surrounded by the horizontal rib 15H formed in the row direction H and the longitudinal rib 15V formed in the column direction V. In the longitudinal rib 15V to partition among two or more auxiliary cells 19 being arranged along the row direction H is formed each of horizontal communicating apertures (path) 20A used to make the auxiliary cells 19 being adjacent to one another communicate with one another and, in the horizontal rib 15H to partition between the display cells 18 arranged in the column direction V and the auxiliary cells 19 is formed each of longitudinal communicating apertures (path) 20B to make each of the display cells 18 communicate with each of the auxiliary cells 19. The longitudinal communicating apertures 20B are formed above each of the bus electrodes 13. Each of the horizontal communicating apertures 20A is used to circulate discharge gas among two or more auxiliary cells 19, while each of the longitudinal communicating apertures 20B is used to circulate discharge gas between each of the display cells 18 and each of the auxiliary cells 19. In the example shown in FIG. 3, each of the longitudinal communicating apertures 20B reaches a surface of the white dielectric layer 14, however, the present invention is not limited to this. That is, as shown in FIG. 4, each of the longitudinal communicating apertures 20B may extend on a way in a direction of a depth of the white dielectric layer 14. This is also true for each of the horizontal communicating apertures 20A.

In the display cell 18, the U-shaped transparent electrode 5A making up the scanning electrode 5 and the U-shaped transparent electrode 6A making up the sustaining electrode 6 are arranged so as to face each other with the surface discharge gap 7A being interposed between the transparent electrode 5A and the transparent electrode 6A. In the auxiliary cell 19, the protruded electrode 5B making up the scanning electrode 5 and the protruded electrode 6B making up the sustaining electrode 6 are arranged so as to face each other with the surface discharge gap 7B being interposed between the protruded electrodes 5B and 6B. By constructing as above, interference of discharge between the auxiliary cells 19 which communicate with each other via each of the horizontal communicating apertures 20A is prevented. The scanning electrode 5 and the sustaining electrode 6 are arranged in a manner in which the scanning electrode 5 and sustaining electrode 6 are used partially and commonly in both the display cell 18 and auxiliary cell 19. The bus electrode 5B making up each of the auxiliary cells 19 is integrated into a belt-shaped bus base 5C and is connected to a part of the transparent electrode 5A and, similarly, the bus electrode 6B making up each of the auxiliary cells 19 is integrated into a belt-shaped bus base 6C and is connected to a part of the transparent electrode 6A. The transparent electrode 5SA making up the scanning electrode 5 is so constructed that each of the transparent electrodes 5A and each of the longitudinal communicating apertures 20B do not overlap in a depth direction (see FIG. 3) and, therefore, erroneous discharge caused by spreading of discharge occurred in the auxiliary cell 19 into the display cell 18. The belt-shaped bus base 6C is placed on the horizontal rib 15H. Each of the belt-shaped bus bases 5C and 6C is formed at the same time when each of the bus electrodes 5B and 6B is formed.

Also, in the auxiliary cell 19, since only discharge not directly associated with displaying is made to occur, a light-shielding portion is formed therein, which causes light emitted by discharge not to be able to be seen from a displaying side of the PDP 10. By this, contrast is improved. More specifically, a light-shielding material layer is formed between the first insulating substrate 4 and the transparent dielectric layer 8 in a portion corresponding to the auxiliary cell 19 in the front substrate 1. As a material for the light shielding material layer, a black inorganic pigment, for example, iron oxide or a like is used. Also, instead of the light-shielding portion, a filter that can absorb a wavelength band of light emitted by discharge gas may be mounted on a displaying side of the PDP 10. Since a phosphor layer is not formed in the auxiliary cell 19, light output from the auxiliary cell 19 has a wavelength band of light emitted by discharge gas and, therefore, only by cutting the wavelength band of the light using the filter, the same effect as obtained by the light-shielding operation can be exerted. By configuring so, additional costs of forming the light-shielding portion can be reduced.

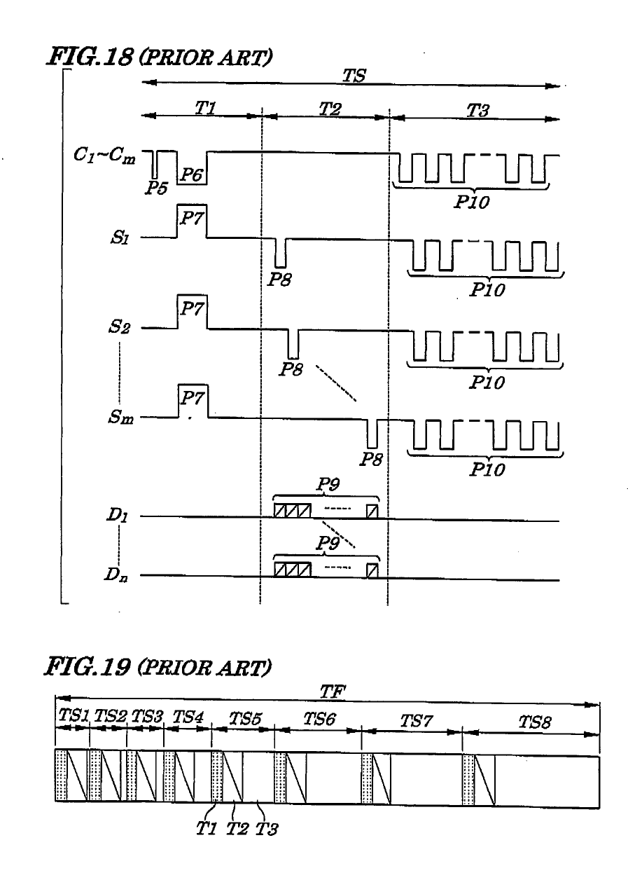

Next, a method for driving the PDP 10 of the first embodiment is described by referring to FIGS. 5 to 7. In the driving method, as in the case of the conventional driving method shown in FIGS. 18 and 19, one field TF is divided into some sub-fields TS and one sub-field TS is made up of a pre-discharging period T1 as shown in FIG. 5, a scanning period T2 as shown in FIG. 6, and a sustaining period T3 as shown in FIG. 7. However, waveforms of a voltage to be applied and/or a manner of occurrence of discharge in each of periods T1 to T3 are different greatly from those employed in the conventional driving method. In the conventional driving method, voltages each having a same waveform are applied to any row except the case of application of a scanning pulse PB. In the embodiment of the present invention, a waveform of a voltage to be applied differs depending on whether the voltage is applied to an odd row or an even row.

First, operations in the pre-discharging period T1 are described-by using the diagrams of waveforms of voltages to be applied shown in FIG. 5 and the diagram shown in FIG. 8. In FIG. 5, electrodes “Sn+1” to “Sn+3” show the scanning electrodes 5 which correspond respectively to the cell on “n+1st” to “n+3rd” rows. Electrodes “Codd” and “Ceven” show the sustaining electrodes 6 which correspond respectively to an odd-numbered line and an even-numbered line. Each of numbers (1) to (5) in FIG. 5 and FIG. 8 denotes tilting corresponding to each operation. An arrangement of wall charges to be formed following each of the timing (1) to (5) is also shown in FIG. 8. As shown in FIG. 5, prior to a start of an operation in the pre-discharging period Ti, in order to erase a state resulting from sustaining discharge (1) and (2) occurred in a sub-field TS existing immediately before the pre-discharging period T1, an erasing pulse P5 is applied to the scanning electrodes with timing of (3). After that, a priming pulse P6 is applied in a manner in which discharge occurs only in the auxiliary cell 19. In the embodiment, pre-discharge occurs in a cell on an odd-numbered line. Next, pre-discharge occurs in a cell on an even-numbered line. At this time point, wall charges are formed only in the auxiliary cell 19 (after the timing of (5)). By priming effect of the pre-discharge, not only writing discharge can be made to easily occur in the scanning period T2, as described later, but also internal electric fields are generated in the auxiliary cell 19 by wall charges formed by the auxiliary cell 19. This pre-discharge occurs only in the auxiliary cell 19 and does not occur in the display cell 18. That is, by intercepting light from the auxiliary cell 19 by using the light-shielding portion, light from the pre-discharge is not seen, which improves contrast.

Next, operations in the scanning period T2 are described by using the diagrams of waveforms of voltages to be applied shown in FIG. 6 and the diagram shown in FIG. 9. During the scanning period T2, a scanning pulse PB is applied in a line-sequential scanning manner. In a cell corresponding to the scanning pulse P8, whether or not writing discharge is made to occur in the display cell 18 is determined depending on whether a pulse P9 is applied to the data electrode 5. Here, when the scanning pulse P8 is applied, since an internal electric field is generated due to wall charges by the pre-discharge in the auxiliary cell 19, before the timing of (1), superimposition of the voltage of the scanning pulse PB on the voltage of the internal electric field in the auxiliary cell 19 exceeds the discharge starting voltage and, therefore, discharge occurs in the auxiliary cell 119, irrespective of whether the data pulse P9 is applied or not with the timing of (1). At this time point, since, in the auxiliary cell 19, there exists a high voltage produced by the superimposition of the voltage of the internal electric field and the voltage of the scanning pulse P8, discharge in the auxiliary cell 19 occurs in a time being shorter than that required for occurrence of the writing discharge in the display cell 18. Moreover, since the horizontal communicating aperture 20A that enables discharge gas to be circulated between the auxiliary cells 19 has been formed, charged particles flow in the auxiliary cells 19 adjacent to one another and become a priming for discharging and, therefore, even in the auxiliary cell 19 where discharge does not occur easily, discharge occurs in a short time. If discharge occurs in the auxiliary cell 19, produced charged particles spread through the longitudinal communicating aperture 20B from the auxiliary cell 19 to the display cell 18 and the charged particles become the priming for discharging which causes writing discharge in the display cell 18 to occur in a short time with the timing from (2) to (3). That is, even by a short width of the scanning pulse P8, writing discharge can be made to occur with reliability.

Finally, operations in the sustaining period T3 are described by using the diagrams of waveforms of voltages to be applied shown in FIG. 7 and the diagram shown in FIG. 10. During the sustaining period T3, prior to the first sustaining discharge (with the timing (2)) in the display cell 18, discharge occurs in all the auxiliary cells 19. This is because wall charges are formed due to auxiliary discharge occurred in all the auxiliary cells 19 during the scanning period T2 which causes discharge to occur by a first pulse during the sustaining period T3. The discharge in the auxiliary cell 19 easily occurs even by a short sustaining pulse P10 since, as in the case of the discharge during the scanning period T2, the auxiliary cells 19 communicate with one another via the horizontal communicating aperture 20A. Since these charged particles produced by this discharge spread through the longitudinal communicating aperture 20B from the auxiliary cell 19 to the display cell 18 with the timing of (2) and (3), discharge in the display cell 18 can be made to occur, with reliability, even by a short first sustaining pulse. In the conventional driving method, if a period of time from an end of the scanning period T2 to the application of the first sustaining pulse is long, the first sustaining discharge does not occur easily and discharge does not easily occur unless the sustaining pulse is made long, which makes it difficult to achieve good displaying. In the embodiment of the present invention, even if the first sustaining pulse is short, excellent displaying can be achieved. Following the application of the first sustaining pulse, a sustaining pulse train P10 is applied. At this time point, a pulse with such a voltage that causes sustaining discharge to occur only in the display cell 18 and not to occur in the auxiliary cell 19 is applied after the timing of (4). As a result, occurrence of useless discharge in the auxiliary cell 19 can be prevented, thus preventing an increase in wasteful power consumption.

Moreover, in the above embodiment, the example is shown in which the voltage having such the waveform as shown in FIG. 5 is applied during the pre-discharging period T1, however, a voltage having another waveform as shown in FIG. 11 can be applied during the pre-discharging period T1. In the case where the voltage having such the waveform as shown in FIG. 5 is applied, pre-discharge occurs in the auxiliary cell 19. However, in the case where the voltage having such the waveform as shown in FIG. 11, the pre-discharge pulse P6 is not applied and the erasing pulse P5 is applied, which causes erasing discharge used to erase sustaining discharge to occur only in the display cell 18. That is, since erasing discharge does not occur in the auxiliary cell 19, wall charges formed by discharge occurring prior to the first sustaining discharge are not erased. The residual wall charges act as an internal electric field within the auxiliary cell 19 and serves as a superimposed voltage used to induce occurrence of auxiliary discharge during the scanning period T2.

Also, during the pre-discharging period T1, a voltage having waveforms as shown in FIG. 12 can be used. The use of the waveforms is characterized in that pre-discharge occurs both in the display cell 18 and in the auxiliary cell 19. That is, when the waveforms are used in a manner in which pre-discharge occurs in the display cell 18 and in the auxiliary cell 19 and in which an erasing pulse is applied so that erasing of pre-discharge occurs in the display cell 18. At this time point, since erasing of pre-discharge does not occur in the auxiliary cell 19, wall charges produced by pre-discharge cannot be erased. The residual wall charges act as the internal electric field in the auxiliary cell 19 and the voltages of the residual charges serve as the superimposed voltage to make auxiliary discharge occur during the scanning period T2.

Thus, in the plasma display device containing the PDP 10 as its main component of the first embodiment of the present invention, the front substrate 1 and the rear substrate 2 are mounted so as to face each other and discharge gas space 3 is formed between the front substrate 1 and rear substrate 2, groups of row electrodes containing at least one scanning electrode 5 are arranged on an inner face of the front substrate 1 in a row direction H and a group of column electrodes made up of data electrodes 13 are arranged on an inner face of the rear substrate 2 in a column direction V being orthogonal to the groups of row electrodes, and a group of unit cells 17 is arranged at intersecting points between the row electrode group and column electrode group and wherein each of the unit cells 17 is made up of the display cell 18 and auxiliary cell 19, both being formed in a manner to be adjacent to each other along a column direction V and the longitudinal communicating aperture 20B to make the display cell 18 communicate with auxiliary cell 19 is formed in the horizontal rib 15H to partition between the display cell 18 and the auxiliary cell 19. Moreover, the light-shielding portion is formed in the auxiliary cell 19. Also, according to the driving method for the plasma display device of the embodiment of the present invention, when the scanning pulse P8 is applied during the scanning period T2, prior to writing discharge, auxiliary discharge occurs in the auxiliary cell 19 and charged particles produced by the auxiliary discharge spread through the longitudinal communicating aperture 20B into the display cell 18. At this time point, since the spread charged particles act as a pariming for writing discharge in the display cell 18, it is possible to make writing discharge occur even by using a short scanning pulse PB. By forming the light-shielding portion in the auxiliary cell 19, degradation in contrast can be prevented. Therefore, an excellent image can be displayed, without an increase in costs caused by the increased number of driving circuits, by simultaneous achievement of shortening of a scanning period while writing discharge is made to occur with reliability and of improvement of contrast.

### Second Embodiment

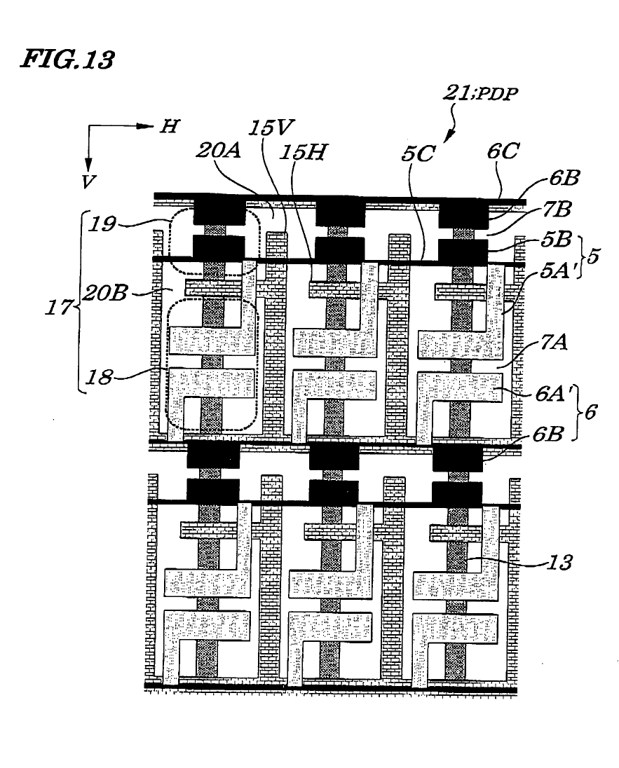

FIG. 13 is a plan view schematically showing configurations of a PDP 21 making up a main component of a plasma display device according to a second embodiment of the present invention. Configurations of the PDP 21 of the second embodiment differ greatly from those employed in the first embodiment in that a place where a longitudinal communicating aperture is formed is changed and a shape of a transparent electrode is changed. The PDP 21 making up a main component of the plasma display device of the embodiment is so configured, as shown in FIG. 13, that a longitudinal communicating aperture 20B is formed at an end of a display cell 18 and, in the display cell 18, an L-shaped transparent electrode 5A′ making up a scanning electrode 5 and an L-shaped transparent electrode 6A′ making up a sustaining electrode 6 are arranged in a manner to face each other with a surface discharge gap 7A being interposed between the L-shaped transparent electrodes 5A′ and 6A′. Except these, the configurations are the same as described in the first embodiment. Therefore, in FIG. 13, same reference numbers are assigned to parts having the same function as those shown in FIG. 1 and their descriptions are omitted accordingly. Its driving method is the same as in the first embodiment.

By configuring as above, since it is possible for transparent electrodes making up a pair of surface discharge electrodes in the display cell 18 to have a degree of freedom in its shape, designing of the pair of surface discharge electrodes is made easy. In the second embodiment, also, since the L-shaped transparent electrodes 5A′ and 6A′ and the longitudinal communicating aperture 20B do not overlap in a depth direction, as in the case of the first embodiment, erroneous discharge caused by spreading of discharge occurred in an auxiliary cell 19 into the display cell 18 can be prevented.

Thus, approximately the same effect obtained in the first embodiment can be achieved in the second embodiment.

### Third Embodiment

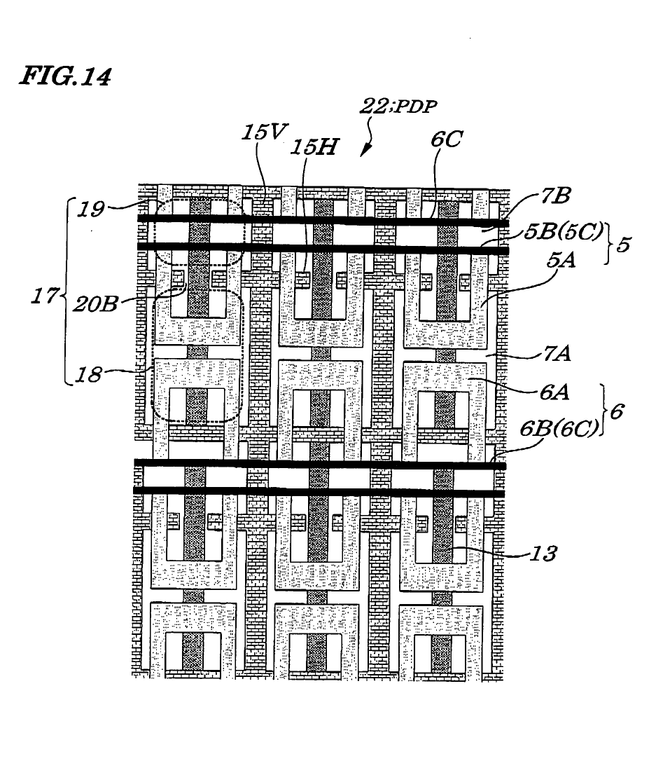

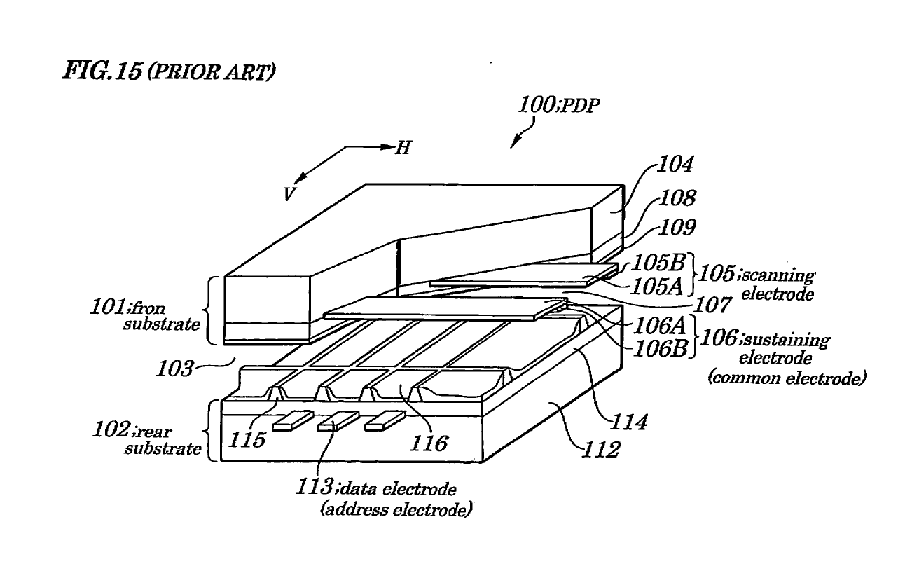

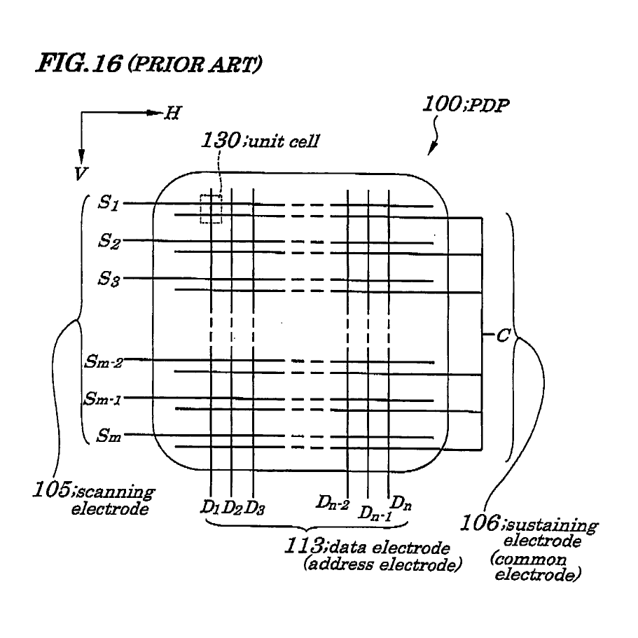

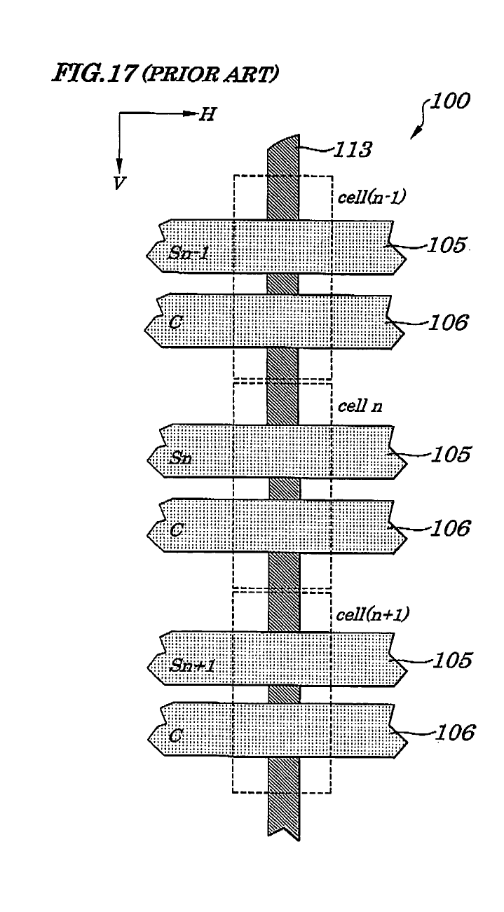

FIG. 14 is a plan view schematically for showing configurations of a PDP 22 making up a main component of a plasma display device according to a third embodiment of the present invention. Configurations of the PDP 22 of the third embodiment differ greatly from those employed in the first embodiment in that no horizontal communicating aperture exists and configurations of an auxiliary cell are changed. In the PDP 22 making up a main component of the plasma display device of the third embodiment, as shown in FIG. 14, such a horizontal communicating aperture 20A as employed in the first embodiment does not exist and, in an auxiliary cell 19, a belt-shaped bus base portion 5C making up a scanning electrode 5 and a belt-shaped bus base portion 6C making up a sustaining electrode 6 are arranged in a manner to face each other with a surface discharge gap 7B interposed between the belt-shaped bus base portions 5C and 6C.

By configuring as above, following effects can be obtained. That is, though discharge gas cannot be circulated among the auxiliary cells 19, such the horizontal communicating aperture 20A to make both the auxiliary cells 19 communicate with one another as employed in the first embodiment are not required and the U-shaped transparent electrodes 5A and U-shaped transparent electrodes 6A are also not necessary and, therefore, the configurations of the PDP 22 can be simplified and a process margin is made wide. Moreover, the driving method is the same as employed in the first embodiment.

Thus, approximately the same effect obtained in the first embodiment can be achieved in the third embodiment.

It is apparent that the present invention is not limited to the above embodiments but may be changed and modified without departing from the scope and spirit of the invention. For example, in the above embodiments, the example is explained in which the pair of surface discharge electrodes in the auxiliary cell is constructed of bus electrodes, however, this may be constructed by using transparent electrodes. Also, the example is described in which each of the row electrode groups is made up of the scanning electrode and sustaining electrode, however, it may be constructed of the scanning electrode only. Also, the waveforms of an applied voltage are merely examples and other waveforms of an applied voltage may be employed so long as the waveform is such that it makes wall charges be residual in the auxiliary cell 19. For example, in each of the embodiments, when pre-discharge and erasing discharge are made to occur in the auxiliary cell, in all the cases, ramp waveforms are used, however, such the pre-discharge pulse having a square wave as shown in the conventional example in FIG. 18 may be used. In general, light emitted by discharge using a ramp waveform is feeble and use of the ramp waveform is suitable to pre-discharge occurring to improve contrast, however, in the embodiment of the present invention, the auxiliary cell 19 is hidden by the light-shielding portion and, therefore, occurrence of intense discharge using a square wave does not degrade contrast. Moreover, during the sub-field, such the combination of waveforms of an applied voltage as shown in FIGS. 5, 11, and 12 may be employed. That is, in the case of eight sub-fields, combined use of the waveform of an applied voltage shown in FIG. 8 only in one sub-field, another waveforms shown in FIG. 4 in three sub-fields, and another waveforms shown in FIG. 7 in remaining four sub-fields may be allowed.

1. A plasma display device comprising;
a plasma display panel (PDP) having a first substrate and a second substrate, both being arranged so as to face each other, discharge gas space formed between said first substrate and said second substrate, groups of row electrodes arranged on an inner face of said first substrate along a row direction, groups of column electrodes arranged on an inner face of said second substrate along a column direction so that said groups of row electrodes and said groups of column electrode intersect at right angles, and groups of unit cells formed at intersecting points between said groups of row electrodes and groups of column electrodes,
wherein each of said unit cells is made up of each of display cells formed in a manner to be adjacent to one another along said column direction and used for displaying images and each of auxiliary cells to feed priming for writing discharge to each of said display cells and wherein each of said display cells and is surrounded by a longitudinal rib formed along said column direction and a horizontal rib formed along said row direction, and each of said auxiliary cells is surrounded by the longitudinal rib formed along said column direction and the horizontal rib formed along said row direction, and at least in said horizontal rib is formed each of longitudinal communicating apertures to make each of said display cells communicate with each of said auxiliary cells.

2. The plasma display device according to claim 1, wherein each of horizontal communicating apertures to make said auxiliary cells being adjacent to one another communicate with one another is formed in said longitudinal rib.

3. The plasma display device according to claim 1, wherein said groups of row electrodes include at least scanning electrodes and groups of column electrodes are made up of data electrodes.

4. The plasma display device according to claim 3, wherein said groups of row electrodes include sustaining electrodes.

5. The plasma display device according to claim 1, wherein said groups of row electrodes include scanning electrodes and sustaining electrodes, and groups of column electrodes are made up of data electrodes, and
wherein, in each of said display cells, said scanning electrodes are arranged so as to face each other with a surface discharge gap being interposed between said scanning electrodes and, in each of said auxiliary cells, said sustaining electrodes are arranged so as to face each other with another surface discharge gap being interposed between said sustaining electrodes.

6. The plasma display device according to claim 5, wherein, in each of said display cells, a transparent electrode of each of said scanning electrodes and a transparent electrode of each of said sustaining electrodes face each other with a surface discharge gap being interposed between these two transparent electrodes of each of said scanning electrodes and sustaining electrodes and, in each of said auxiliary cells, a bus electrode of each of said scanning electrodes and a bus electrode of each of said sustaining electrodes are arranged so as to face each other with a surface discharge gap between these two bus electrodes of each of said scanning electrodes and sustaining electrodes,

7. The plasma display device according to claim 3, wherein each of said scanning electrodes and each of said longitudinal communicating apertures do not overlap one another in a depth direction.

8. The plasma display device according to claim 1, wherein each of said auxiliary cells has a light-shielding portion to intercept light emitted by discharge.

9. The plasma display device according to claim 1, wherein each of said auxiliary cells has no phosphor layer.

10. The plasma display device according to claim 5, wherein each of said scanning electrodes and each of said longitudinal communicating apertures do not overlap one another in a depth direction.

11. The plasma display device according to claim 5, wherein each of said auxiliary cells has a light-shielding portion to intercept light emitted by discharge.

12. The plasma display device according to claim 5, wherein each of said auxiliary cells has no phosphor layer.

13. A method for driving a plasma display device made up of a PDP having a first substrate and a second substrate, both being arranged so as to face each other, discharge gas space formed between said first substrate and said second substrate, groups of row electrodes arranged on an inner face of said first substrate along a row direction, groups of column electrodes arranged on an inner face of said second substrate along a column direction so that said groups of row electrodes and said groups of column electrode intersect at right angles, and groups of unit cells formed at intersecting points between said groups of row electrodes and groups of column electrodes, wherein each of said unit cells is made up of each of display cells formed in a manner to be adjacent to one another along said column direction and used for displaying images and each of auxiliary cells to feed priming for writing discharge to each of said display cells and wherein each of said display cells is surrounded by a longitudinal rib formed along said column direction and a horizontal rib formed along said, row direction, and each of said auxiliary cells is surrounded by the longitudinal rib formed along said column direction and a horizontal rib formed along said row direction, and at least in said horizontal rib is formed each of longitudinal communicating apertures to make each of said display cells communicate with each of said auxiliary cells, said method comprising:
a step of causing discharge to occur in each of said auxiliary cells, when a scanning pulse is applied to each of said scanning electrodes, irrespective of occurrence or non-occurrence of writing discharge in each of said display cells.

14. The method for driving the plasma display device according to claim 13, wherein said step is achieved by making a negative charge be accumulated on each of said scanning electrodes in each of said auxiliary cells prior to application of said scanning pulse.

15. The method for driving the plasma display device according to claim 14, wherein said step is achieved by applying a voltage having a waveform to cause discharge by using each of said scanning electrodes as an anode to occur only in each of said auxiliary cells before operations start in a scanning period.

16. The method for driving the plasma display device according to claim 14, wherein said step is achieved by applying a voltage having a waveform to cause discharge by using each of said scanning electrodes as an anode to occur only in each of said auxiliary cells in a sustaining period.

17. The method for driving the plasma display device according to claim 14, wherein said step is achieved by applying a voltage having a waveform to cause discharge by using each of said scanning electrodes as an anode to occur in each of said display cells and each of said auxiliary cells before operations start in a scanning period and by applying then a voltage having a waveform to cause discharge by using each of said scanning electrodes as a cathode to occur only in each of said display cells.

18. A method for driving a plasma display device made up of a PDP having a first substrate and a second substrate, both being arranged so as to face each other, discharge gas space formed between said first substrate and said second substrate, groups of row electrodes arranged on an innerface of said first substrate along a row direction, groups of column electrodes arranged on an inner face of said second substrate along a column direction so that said groups of row electrodes and said groups of column electrode intersect at right angles, and groups of unit cells formed at intersecting points between said groups of row electrodes and groups of column electrodes, wherein each of said unit cells is made up of each of display cells formed in a manner to be adjacent to one another along said column direction and used for displaying images and each of auxiliary cells to feed priming for writing discharge to each of said display cells and wherein each of said display cells is surrounded by a longitudinal rib formed along said column direction and a horizontal rib formed along said row direction, and each of said auxiliary cells is surrounded by the longitudinal rib formed along said column direction and a horizontal rib formed along said row direction and at least in said horizontal rib is formed each of longitudinal communicating apertures to make each of said display cells communicate with each of said auxiliary cells, said method comprising:
a step of making a voltage of a sustaining pulse to be applied to each of said scanning electrodes on odd-numbered lines be in phase with a voltage of a sustaining pulse to be applied to each of said sustaining electrodes on even-numbered lines in a sustaining period, and by making a voltage of a sustaining pulse to be applied to each of said scanning electrodes on even-numbered lines be in phase with a voltage of a sustaining pulse to be applied to each of said sustaining electrodes on odd-numbered line in said sustaining period.

19. A method for driving a plasma display device made up of a PDP having a first substrate and a second substrate, both being arranged so as to face each other, discharge gas space formed between said first substrate and said second substrate, groups of row electrodes arranged on an inner face of said first substrate along a row direction, groups of column electrodes arranged on an inner face of said second substrate along a column direction so that said groups of row electrodes and said groups of column electrode intersect at right angles, and groups of unit cells formed at intersecting points between said groups of row electrodes and groups of column electrodes, wherein each of said unit cells is made up of each of display cells formed in a manner to be adjacent to one another along said column direction and used for displaying images and each of auxiliary cells to feed priming for writing discharge to each of said display cells and wherein each of said display cells is surrounded by a longitudinal rib formed along said column direction and a horizontal rib formed along said row direction, and each of said auxiliary cells is surrounded by the longitudinal rib formed along said column direction and a horizontal rib formed along said row direction and at least in said horizontal rib is formed each of longitudinal communicating apertures to make each of said display cells communicate with each of said auxiliary cells, said method comprising:
a step of applying a sustaining pulse to cause discharge to occur in each of said auxiliary cells before first sustaining discharge starts to occur in each of said display cells in a sustaining period.
